(19) United States
(12) Patent Application Publication
(10) Pub. No.: US 2007/0018966 A1
(43) Pub. Date: Jan. 25, 2007

(54) Predicted object location

(76) Inventors: Michael M. Blythe, Albany, OR (US); Wyatt Huddleston, Allen, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/188,397

(22) Filed: Jul. 25, 2005

(51) Int. Cl. G09G 5/00

(52) U.S. Cl. 345/173

(57) ABSTRACT

Embodiments of predicting an object location are disclosed.

### BACKGROUND

Some display systems have interactive capability which allows a display, screen, monitor, etc. of the system to receive input commands and/or input data from a user. In such systems, capacitive touch recognition and resistive touch recognition technologies have been used to determine the x-y location of a touch point on the display. However, the ways in which the x-y location of a touch point have been determined have not been as efficient and/or fast as desired.

### BRIEF DESCRIPTION OF THE DRAWINGS

Detailed description of embodiments of the present disclosure will be made with reference to the accompanying drawings:

FIG. 1 shows an embodiment of a desktop with multiple embodiments of graphical user interfaces;

FIG. 2 shows an embodiment of a graphical user interface with multiple regions of interest (where user or other inputs are expected);

FIG. 3 shows an embodiment of a graphical user interface with electronically generated game pieces and a window with a thumbnail image of the game pieces properly arranged;

FIG. 4 shows an embodiment of a predictive imaging system;

FIG. 5 shows an embodiment of a computing device of the predictive imaging system of FIG. 4 in greater detail;

FIG. 6 shows an embodiment of detecting locations (on a display) of multiple moving objects, and determining object vectors and a region of interest for attempted object detection at a future time;

FIG. 7 shows embodiments of varying sample rate and/or region of interest size;

FIG. 8 shows an embodiment of an object changing in both direction and speed in relation to an embodiment of a display, and how a region of interest can be determined in consideration of these changes; and

FIG. 9 is a flowchart for an embodiment of a predictive imaging method.

### DETAILED DESCRIPTION

The following is a detailed description for carrying out embodiments of the present disclosure. This description is not to be taken in a limiting sense, but is made merely for the purpose of illustrating the general principles of the embodiments of the present disclosure.

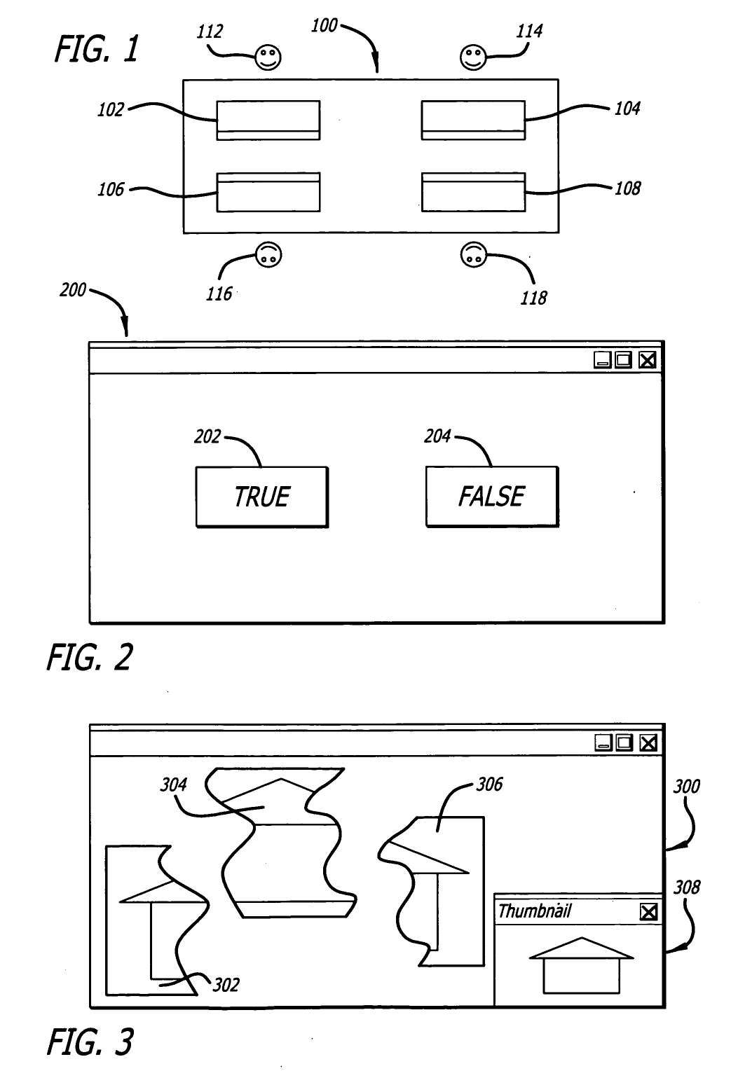

Embodiments described herein involve using predictive methods to increase the efficiency of an image comparison methodology for detecting objects (e.g., a fingertip, a game piece, interactive token, etc.) making surface or near-surface contact with a display surface for a projected image. FIG. 1 shows an example desktop 100 with multiple graphical user interfaces 102, 104, 106, and 108 generated for users 112, 114, 116, and 118, respectively. The desktop 100 illustrates an example of how multiple users can be presented with GUIs (or other interactive interfaces) which are controlled by one or more computer-executable programs (e.g., an operating system, or application software). Graphical user interfaces can include windows as well as other types of interfaces. Examples of applications software include, but are not limited to, web browsers, word processing programs, e-mail utilities, and games.

FIG. 2 shows an example graphical user interface 200 with multiple regions of interest (ROI) where user or other inputs are expected. In this example, a region 202 includes the word “TRUE⇄, and a region 204 includes the word “FALSE”. In this example, the operating system or application software controlling the generation of the graphical user interface 200 also designates the regions 202 and 204 as “regions of interest” because it is within these regions that an input (typically a user input) is expected. Such GUIs may be used in applications that present buttons (e.g., radiobuttons), checkboxes, input fields, and the like to a user.

In an embodiment where the graphical user interface 200 is provided at a touch screen, a user input can be provided by briefly positioning the user's fingertip at or near one of the regions 202 and 204 depending upon whether the user wishes to respond to a previously presented inquiry (not shown) with an indication of TRUE or FALSE. It should also be appreciated that user inputs can be provided at regions of interest using various user input mechanisms. For example, some displays are configured to detect various objects (e.g., at or near the surface of the display). Such objects can include fingertips, toes or other body parts, as well as inanimate objects such as styluses, gamepieces, and tokens. For purposes of this description, the term “object” also includes photons (e.g., a laser pointer input mechanism), an electronically generated object (such as input text and/or a curser positioned over a region of interest by a person using a mouse, keyboard, or voice command), or other input electronically or otherwise provided to the region of interest.

In other embodiments, a region of interest may change depending upon various criteria such as the prior inputs of a user and/or the inputs of other users. FIG. 3 shows an example graphical user interface 300 with electronically generated puzzle pieces 302, 304 and 306 and a window 308 with a thumbnail image of the puzzle pieces 302, 304 and 306 properly arranged (to guide the would-be puzzle solver). It should be appreciated that electronically generated puzzles, games of any type, as well as other GUIs generated by programs configured to receive inputs from multiple users can be simultaneously presented to multiple users or players as shown in FIG. 1.

Referring again to the example shown in FIG. 3, when one player drags (or otherwise repositions) a game piece to a particular location on the display, the other players will see this happening on the GUIs associated with them, and the application software controlling the GUI makes appropriate adjustments to the region(s) of interest based on the movement of this game piece. For example, as the pieces of the puzzle are arranged and fit together, there will be fewer and fewer “holes” in the puzzle, and therefore there will be fewer and fewer “loose” pieces of the puzzle that a player is likely to manipulate using graphical user interface 300 and attempt to fit into one of the holes. As such, in an embodiment, the electronic jigsaw puzzle application software is configured to dynamically adjust the regions of interest to be limited to those portions of the display that are being controlled to generate visual representations of the pieces that have not yet been fit into the puzzle.

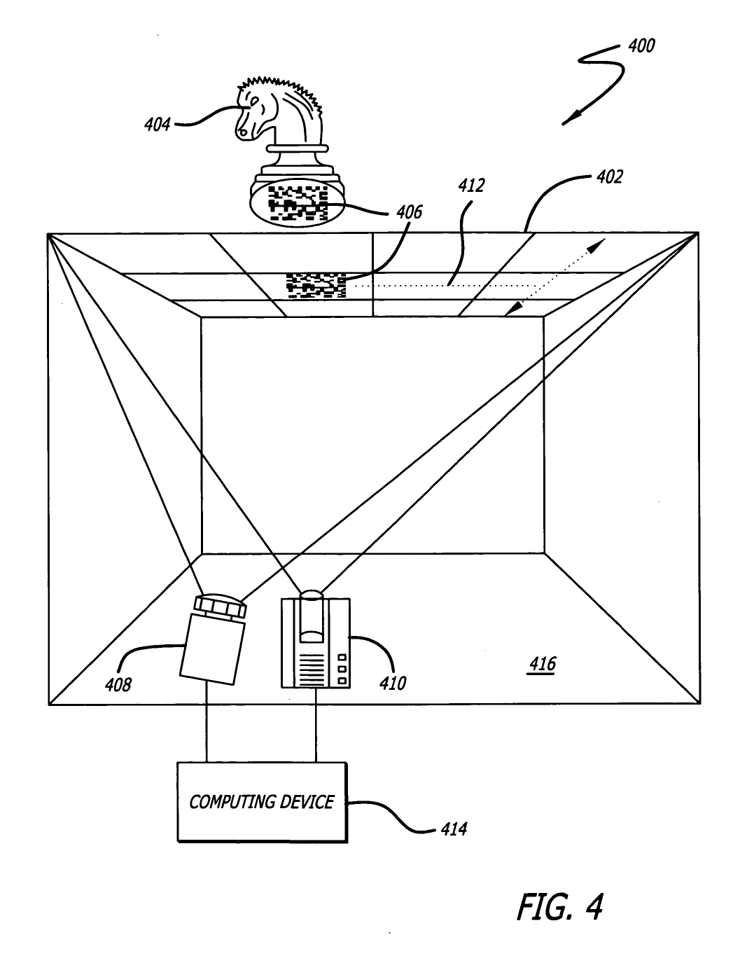

Referring to FIG. 4, an example predictive imaging system 400 includes a surface 402. In this embodiment, the surface 402 is positioned horizontally, although it should be appreciated that other system configurations may be different. For example, the surface 402 can also be tilted for viewing from the sides. In this example, the system 400 recognizes an object 404 placed on the surface 402. The object 404 can be any suitable type of object capable of being recognized by the system 400 such as a device, a token, a game piece, or the like. Tokens or other objects may have imbedded electronics, such as a LED array or other communication device that can optically transmit through the surface 402 (e.g., screen).

In this example, the object 404 has a symbology 406 (e.g., attached) at a side of the object 404 facing the surface 402 such that when the object 404 is placed on the surface 402, a camera 408 can capture an image of the symbology 406. To this end, in various embodiments, the surface 402 can be any suitable type of translucent or semi-translucent surface (such as a projector screen) capable of supporting the object 404. In such embodiments, electromagnetic waves pass through the surface 402 to enable recognition of the symbology 406 from the bottom side of the surface 402. The camera 408 can be any suitable type of capture device such as a charge-coupled device (CCD) sensor, a complementary metal oxide semiconductor (CMOS) sensor, a contract image sensor (CIS), or the like.

The symbology 406 can be any suitable type of machine-readable symbology such as a printed label (e.g., a printed label on a laser printer, an inkjet printer), infrared (IR) reflective label, ultraviolet (UV) reflective label, or the like. By using an UV or IR illumination source (not shown, e.g., located under the surface 402) to illuminate the surface 402 from the bottom side, a capture device such as an UV/IR sensitive camera (for example, camera 408), and UV/IR filters (placed in between the illumination source such a capture device, objects on the surface 402 can be detected without utilizing complex image math. For example, when utilizing IR, tracking the IR reflection can be used for object detection without applying image subtraction.

By way of example, the symbology 406 can be a bar code, whether one dimensional, two dimensional, or three dimensional. In another embodiment, the bottom side of the object 404 is semi-translucent or translucent to allow changing of the symbology 406 exposed on the bottom side of the object 404 through reflection of electromagnetic waves. Other types of symbology can be used, such as the LED array previously mentioned. Also as previously discussed, in various embodiments, certain objects are not provided with symbology (e.g., a fingertip object recognized by a touch screen).

The characteristic data provided by the symbology 406 can include one or more, or any combination of, items such as a unique identification (ID), an application association, one or more object extents, an object mass, an application-associated capability, a sensor location, a transmitter location, a storage capacity, an object orientation, an object name, an object capability, and an object attribute. The characteristic data can also be encrypted in various embodiments. When using the LED array mentioned previously in an embodiment, this information and more can be sent through the screen surface to the camera device.

In an embodiment, the system 400 determines that changes have occurred with respect to the surface 402 (e.g., the object 404 is placed or moved) by comparing a newly captured image with a reference image that, for example, was captured at a reference time (e.g., when no objects were present on the surface 402).

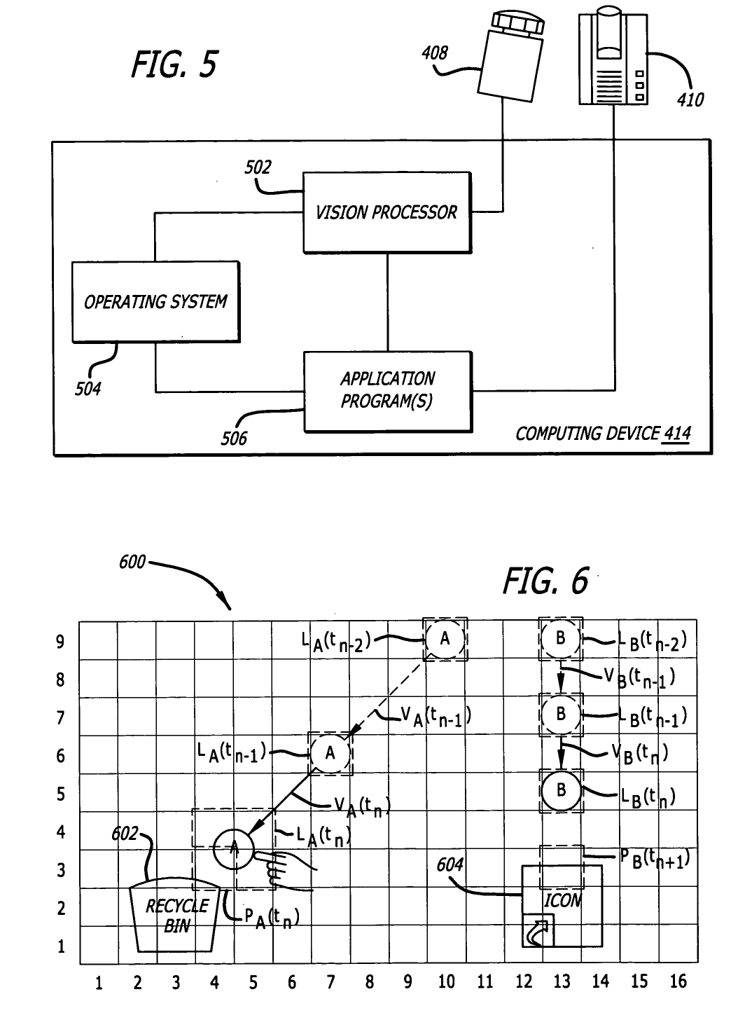

The system 400 also includes a projector 410 to project images onto the surface 402. In this example, a dashed line 412 designates permitted moves by a chess piece, such as the illustrated knight. The camera 408 and the projector 410 are coupled to a computing device 414. As will be further discussed with reference to FIG. 5, in an embodiment, the computing device 414 is configured to control the camera 408 and/or the projector 410, e.g., to capture images at the surface 402 and project images onto the surface 402.

Additionally, as shown in this embodiment, the surface 402, the camera 408, and the projector 410 can be part of an enclosure 416, e.g., to protect the parts from physical elements (such as dust, liquids, and the like) and/or to provide a sufficiently controlled environment for the camera 408 to be able to capture accurate images and/or for the projector to project brighter pictures. The computing device 414 (e.g., a notebook computer) can be provided wholly or partially inside the enclosure 416, or wholly external to the enclosure 416.

Referring to FIG. 5, in an embodiment, the computing device 414 includes a vision processor 502, coupled to the camera 408 to determine when a change to objects on the surface 402 occurs such as change in the number, position, and/or direction of the objects of the symbology. In an embodiment, the vision processor 502 performs an image comparison (e.g., between a reference image of the bottom of the surface 402 and a subsequent image) to recognize that the symbology 406 has changed in value, direction, or position. In an embodiment, the vision processor 502 performs a frame-to-frame subtraction to obtain the change or delta of images captured through the surface 402.

In this embodiment, the vision processor 502 is coupled to an operating system (O/S) 504 and one or more application programs 506. In an embodiment, the vision processor 502 communicates information related to changes to images captured through the surface 402 to one or more of the O/S 504 and the application programs 506. In an embodiment, the application program(s) 506 utilizes the information regarding changes to cause the projector 410 to project a desired image. In various embodiments, the O/S 504 and the application program(s) 506 are embodied in one or more storage devices upon which is stored one or more computer-executable programs.

In various embodiments, an operating system and/or application program uses probabilities of an object being detected at particular locations within an environment that is observable by a vision system to determine and communicate region of interest (ROI) information for limiting a vision capture (e.g., scan) operation to the ROI. In some instances, there are multiple ROIs. For example, in a chess game (FIG. 4), probabilities for various ROIs can be determined based on the positions of already recognized objects (game pieces) as well as likely (legal) moves that a player might make given the positions of other pieces on the board. In an example wherein user inputs are expected in certain areas but not other areas, e.g., where a GUI provides True and False input boxes (FIG. 2), the probability of an acceptable user input being outside these regions of interest is zero, and therefore image capturing can be substantially or completely confined to these ROIs. In various embodiments, an ROI can change (e.g., is repositioned, resized and/or reshaped) in response to a user input and/or to a change in the GUI which is being controlled by the O/S and/or the application program.

In an embodiment, a method includes using a computer-executable program to process information pertaining to an object detected at or near a display to determine a predicted location of the object in the future, and using the predicted location to capture an image of less than an available area of the display. In an embodiment, an operating system and/or application program is used to provide a graphical user interface and to communicate the predicted location to a vision system that will perform the future image capture. Instead of capturing an image of a large fraction of the available display, such as a large fraction of the available display surface area or the available display, such as the available display surface area, in various embodiments the vision system limits its imaging operation to the region of interest. In an embodiment, the computer-executable program is used to monitor location changes of the object to determine the predicted location. In an embodiment, the computer-executable program is used to determine a region of interest that includes the predicted location.

In an embodiment, an apparatus includes a display, a vision system configured for capturing an image of the display, and mechanism for controlling a graphical user interface presented at the display and for controlling the vision system to limit capturing of the image to a region of interest within the display, the region of interest including a predicted next location of an object detected at or near the display. In an embodiment, the mechanism for controlling includes an operating system and/or application software.

In an embodiment, an imaging apparatus includes an operating system configured to process detected object information for an object detected at or near a display controlled by the operating system, generate a predicted location of the object at a future time for limiting a capture of an image of the display to a region of interest that includes the predicted location, and perform an image comparison operation limited to the region of interest.

In an embodiment, an imaging apparatus includes application software configured to process detected object information for an object detected at or near a display controlled by the operating system, generate a predicted location of the object at a future time for limiting a capture of an image of the display to a region of interest that includes the predicted location, and perform an image comparison operation limited to the region of interest.

In an embodiment, an apparatus includes a storage device upon which is stored a computer-executable program which when executed by a processor enables the processor to control a graphical user interface presented at a display and to process information pertaining to an object detected at or near the display to determine a predicted location of the object in the future, to process the information to determine a region of interest within the display that includes the predicted location, and to generate an output signal that controls an image capture device to image a subportion of the display corresponding to the region of interest. In an embodiment, the computer-executable program includes an operating system. In an embodiment, the computer-executable program includes application software. In an embodiment, the information includes one or more of a detected size of the object, changes in a detected location of the object, a detected velocity of the object, a detected acceleration of the object, a time since the object was last detected and a motion vector of the object.

FIG. 6 shows an example of detecting locations (on a display) of multiple moving objects, and determining object vectors and a region of interest for attempted object detection at a future time. In this example, a display 600 (e.g., a touch screen) is partitioned into 144 regions, which may be regions of interest (16×9 ROIs), of equal size. It should be understood that the principles described herein are applicable to other ROI configurations. For example, the boundaries of ROIs can be established in consideration of particular GUI elements seen by a viewer of the display (e.g., driven by the O/S and/or application program) and therefore may or may not be equal in size or shape, or symmetrical in their arrangement.

Various embodiments involve dynamic user inputs (such as a changing detected location of a fingertip object being dragged across a touch screen). In the example shown in FIG. 6, an object denoted “A” is a fingertip object being dragged across the display 600 toward an icon 602 denoted “Recycle Bin”. The object denoted “B” is a fingertip object being dragged toward an icon 604, in this example, a short cut for starting an application program. In FIG. 6, detected locations are denoted “L”, object vectors as “V”, and predicted locations as “P”. In this example, object A was detected as three points in time, tₙ₋₂, tₙ₋₁, and tₙ, at locations L_{A}(tₙ₋₂), L_{A}(tₙ₋₁), and L_{A}(tₙ), respectively, resulting in vectors, V_{A}(tₙ₋₁), and V_{A}(tₙ), as shown. In this example, the velocity of object A, reflected in the slight decrease in length from V_{A}(tₙ₋₁) to V_{A}(tₙ). In this example, object B was detected as three points in time, tₙ₋₂, tₙ₋₁, and tₙ, at locations L_{B}(tₙ₋₂), L_{B}(tₙ₋₁), and L_{B}(tₙ), respectively, resulting in vectors, V_{B}(tₙ₋₁), and V_{B}(tₙ), as shown. In this example, the velocity of object B remained substantially constant as reflected in the lengths of V_{B}(tₙ₋₁) and V_{B}(tₙ). For object B, a predicted location P_{B}(tₙ₊₁) is determined assuming that V_{B}(tₙ₊₁) (not shown) will have the same magnitude and direction as V_{B}(tₙ₋₁) and V_{B}(tₙ).

In some embodiments, the O/S and/or application program can be configured to use predicted locations of objects to more quickly recognize a user input. For example, even though object A, at tₙ, does not yet overlap icon 602, because it was detected within a ROI that includes part of the icon 602 (e.g., a ROI corresponding to a predicted location P_{A}(tₙ) determined assuming that V_{A}(tₙ) would have the same magnitude and direction as V_{A}(tₙ₋₁)), the O/S and/or application program can be configured to, sooner in time than would occur without this prediction, accept into the recycle bin whatever file the user is dragging.

In an embodiment, an imaging apparatus includes a display (e.g., a touch screen) for providing an interactive graphical user interface, a vision system configured for capturing an image of the display to determine a location of an object facing the display, and a processing device programmed to control the display and the vision system and to perform an image comparison using an imaged region of interest less than an available area of the display, e.g., where a region of interest of the display is imaged but not areas outside of the region of interest. In an embodiment, the processing device runs an operating system and/or application program that generates the interactive graphical user interface and communicates the region of interest to the vision system. In an embodiment, the processing device is programmed to monitor changes in a detected location of the object and to use the changes to define the region of interest. In an embodiment, the processing device is programmed to modify the region of interest depending upon a predicted location of the object. In an embodiment, the processing device is programmed to modify the region of interest depending upon an object vector. In another embodiment, the processing device is programmed to use a detected size “S” of the object to define the region of interest. In various embodiments, the region of interest is defined depending upon a detected size of the object.

In an embodiment, a new image (frame) is sampled or otherwise acquired 15-60 times/second. Once an object (e.g., a fingertip) is detected, initially at each subsequent frame, the O/S and/or application program looks in the same location for that same object. By way of example, if there is a +10 pixel motion in X between frames 1 and 2, then for frame 3 the search is initiated 10 more pixels further in X. Similarly, if a 5 pixel motion is detected between frames 1 and 20 (a more likely scenario), then the search is adjusted accordingly (1 pixel per 4 frames). If the object motion vector changes, the search is adjusted according to that change. With this data, in an embodiment, the frequency of the search can be adjusted, e.g., reduced to every other frame or even lower which further utilizes predictive imaging as described herein to provide greater efficiency.

An image capturing frequency can be adjusted, e.g., depending upon prior detected object information, changes to the GUI, and other criteria. For example, the image capturing frequency can be adjusted depending upon prior detected locations of an object. Moreover, a processing device implementing the principles described herein can be programmed to increase a size of the region of interest if a detected location of the object becomes unknown. A processing device implementing the principles described herein can also be programmed to reposition the region of interest depending upon prior detected locations of the object independent of whether a current object location has been detected.

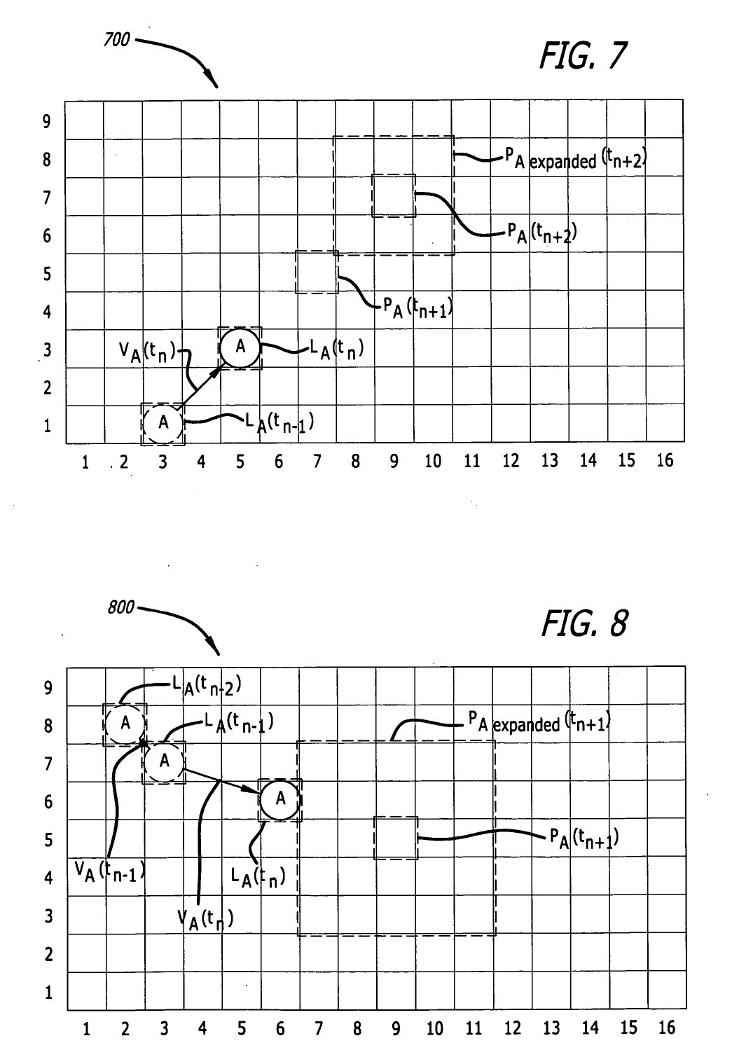

FIG. 7 shows examples of varying sample rate and/or region of interest size. In this example, a display 700 shows an object A that was detected at two points in time, tₙ₋₁ and tₙ, at locations L_{A}(tₙ₋₁) and L_{A}(tₙ), respectively, resulting in vector V_{A}(tₙ), as shown. In this example, the O/S and/or application program determines predicted locations, P_{A}(tₙ₊₁) and P_{A}(tₙ₊₂), by extrapolating V_{A}(tₙ). In an embodiment, the image capture frequency is lowered (e.g., the next image is captured at tₙ₊₂, with no image being captured at tₙ₊₁).

In an embodiment, the region of interest is defined depending upon a time since the object was last detected. This may be useful in a situation where a user drags a file, part, or the like and his finger “skips” during the drag operation. Referring again to FIG. 7, if the object is not detected at tₙ₊₁, an alternate (in this example, expanded in size and further repositioned by extending V_{A}₍ₜₙ)) predicted location P_{Aexpanded}(tₙ₊₂) is used by the O/S and/or application program for controlling the next image capture operation. In another embodiment, the predicted location is not expanded until after a certain number of “missing object” frames. The timing of expanding the predicted location and the extent to which it is extended can be adjusted, e.g., using predetermined or experimentally derived constants or other criteria to control how the search is to be broadened under the circumstances. In another embodiment, the region of interest can be expanded in other ways, e.g., along the last known vector associated with an object gone missing. In such an embodiment, if an object is detected anywhere along the vector, the O/S and/or application program can be configured to assume that it is the missing object and move whatever was being pulled (e.g., a piece of a puzzle) to the location of detection. Thus, in an embodiment, the region of interest is defined depending upon changes in a detected location of the object.

In an embodiment, an imaging method includes a step for predicting a location of an object within an image capture field, using the location predicted to define a region of interest within the image capture field, and using an operating system or application software to communicate the region of interest to a vision system that performs an imaging operation limited to the region of interest. In an embodiment, the step for predicting includes monitoring changes in a detected location of the object. The region of interest can be defined, for example, using a detected size of the object, or changes in a detected location of the object. In an embodiment, the region of interest is increased in size if the detected location becomes unknown. In another embodiment, the method further includes using changes in a detected location of the object to define an object vector. In an embodiment, the region of interest is repositioned within the image capture field depending upon the object vector.

In an embodiment, a method includes acquiring information, for an object moving at or near a display, describing detected locations of the object over time, processing the information to repeatedly generate a predicted location of the object, and continuing to perform an image comparison operation that is limited to a region of interest that includes the predicted location even when the object is no longer detected.

In various embodiments, the region of interest is defined depending upon a detected velocity of the object, or a detected acceleration of the object. FIG. 8 shows an example of an object A changing in both direction and speed in relation to a display 800, and how a region of interest can be determined in consideration of these changes. In this example, object A was detected as three points in time, tₙ₋₂, tₙ₋₁, and tₙ, at locations L_{A}(tₙ₌₂), L_{A}(tₙ₋₁), and L_{A}(tₙ), respectively, resulting in vectors, V_{A}(tₙ₋₁), and V_{A}(tₙ), as shown. In this example, both the direction of movement and the velocity of object A changed from V_{A}(tₙ₋₁) to V_{A}(tₙ). In this example, the O/S and/or application program determines a predicted location P_{A}(tₙ₊₁) by extending V_{A}(tₙ), i.e., assuming that the direction and speed of movement of the object will remain the same as indicated by V_{A}(tₙ). In other embodiments, the ROI around a predicted location P can be expanded when there are changes in the direction and/or speed of movement of the object. For example, predicted location P_{Aexpanded}(tₙ₊₁) can instead be used by the O/S and/or application program for controlling the next image capture operation.

In an example implementation, information such as location L(x,y), velocity VEL(delta x, delta y), predicted location P(x,y), and size S(height, width) is attached to (or associated with) each object (e.g., fingertip touching the screen) and processed to predict the next most likely vector V. For example, at each frame the O/S and/or application program searches for the object centered on P and S*scale in size. In an embodiment, search areas are scaled to take into account the different screen/pixel sizes of particular hardware configurations. To maintain consistency from one system to another, a scale factor (“scale”), e.g., empirically determined, can be used to adjust the search area. If not found, the search expands. Once the search is complete, L, VEL, and P are adjusted, if appropriate, and the cycle repeats. In various embodiments, the ROI is repositioned based on a calculated velocity or acceleration of the object. A “probability function” or other mechanism for determining V and/or P can take a variety of different forms and involve the processing of various inputs or combinations of inputs, and the significance of each input (e.g., as influenced by factors such as frequency of sampling, weighting of variables, deciding when and how to expand the size of a predicted location P, deciding when and how to change to a default parameter, etc.) can vary depending upon the specific application and circumstances.

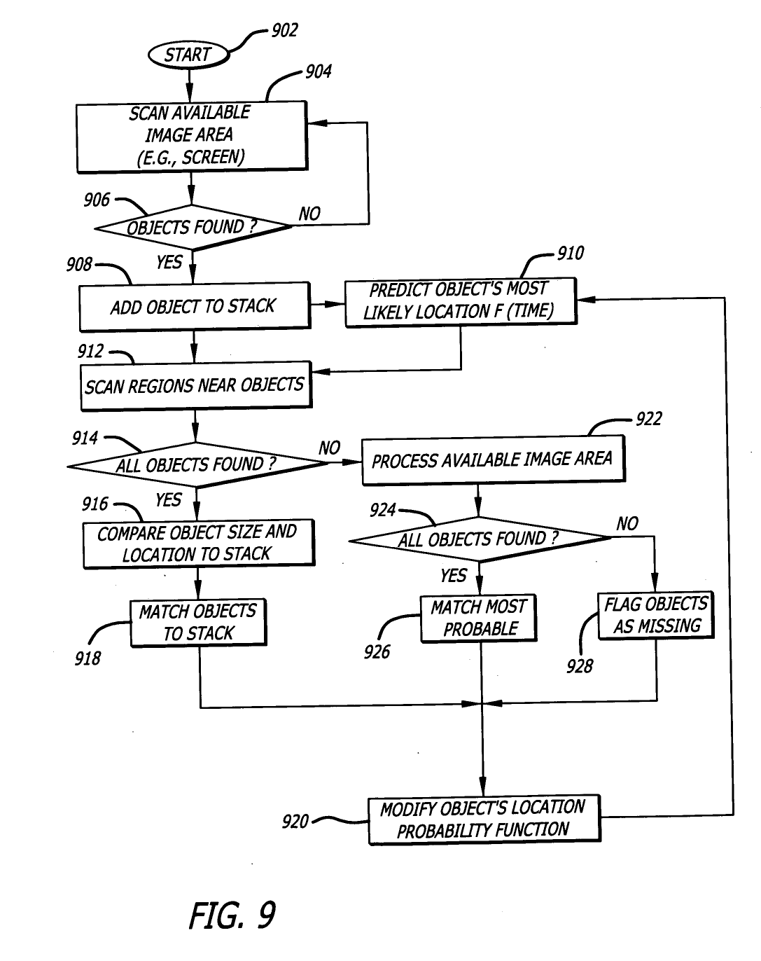

Referring to FIG. 9, an example predictive imaging method 900 begins at step 902. In this embodiment, at step 904, the display, such as the available image area on the display (e.g., screen) is scanned for objects. If objects are found at step 906, they are added to a memory (e.g., stack) at step 908. If not, step 904 is repeated as shown. A probability function is associated with each detected object, e.g., expanding its location. In an embodiment,

$$P ( x ) = \frac{1}{σ \sqrt{2 π}} {ⅇ}^{- {( x - μ )}^{2} / ( 2 {σ}^{2} )}$$

(the normal distribution) is used where: x=last location of object, μ=predicted location of object, and a σ=function of time. As time progresses, the search region increases. For example, the search region is sizeX±3 and sizeY±3 pixels for the first 4 seconds, and changes to ±5 pixels for 5-9 seconds, etc. At step 910, the most likely location of the object is predicted using the function. By way of example, at time zero, an object is at pixel 300,300 on the screen. The next location of the object at some time in the future can be predicted as being, for example, between 299, 299 and 301, 301 (a 9 pixel region). As time increases, this “probability region” can be made bigger.

At step 912, the next image is then processed by looking at regions near the last locations of the objects and not looking at regions outside of this, the boundaries of the regions being determined by the probability function for each object. If all of the objects are found at step 914, they are compared at step 916 to those in memory (e.g., object size and location are compared from image to image) and at step 918 matched objects are stored in the stack. The new locations of the objects (if the objects are detected as having moved) are then used at step 920 to update the probability functions. For example, if an object has moved 10 pixels in the last five frames (images) the O/S and/or application program can begin to look for it 2 pixels away on the same vector during the next frame.

If all of the objects are not found, the process advances to step 922 where the available image area is processed. Alternately, step 922 can provide that a predicted location is expanded (for the next search) to an area of the display that is less than the available image area. In either case, a parallel thread can be used to provide this functionality. At step 924, if all of the objects are found, at step 926 the objects are matched as previously described, and the secondary thread can now be ignored. If all of the objects are still not found, in this embodiment, the missing objects are flagged at step 928 as “missing”. After step 920, the process returns to step 910 where the most likely location of the object is predicted using the function and then advances to step 912 where the next image to be processed is processed.

Although embodiments of the present disclosure have been described in terms of the embodiments above, numerous modifications and/or additions to the above-described embodiments would be readily apparent to one skilled in the art. It is intended that the scope of the claimed subject matter extends to all such modifications and/or additions.

What is claimed is:

1. A method comprising:
using a computer-executable program to process information pertaining to an object detected at or near a display to determine a predicted location of the object in the future; and
using the predicted location to capture an image of less than an available area of the display.

2. The method of claim 1, wherein using a computer-executable program includes using an operating system to provide the graphical user interface and to communicate the predicted location to a vision system that will perform the future image capture.

3. The method of claim 1, wherein using a computer-executable program includes using an application program to provide a graphical user interface and to communicate the predicted location to a vision system that will perform the future image capture.

4. The method of claim 1, further including:
using the computer-executable program to monitor location changes of the object to determine the predicted location.

5. The method of claim 1, further including:
using the computer-executable program to determine a region of interest that includes the predicted location.

6. The method of claim 5, wherein the region of interest is defined depending upon a detected size of the object.

7. The method of claim 5, wherein the region of interest is defined depending upon changes in a detected location of the object.

8. The method of claim 5, wherein the region of interest is defined depending upon a detected velocity of the object.

9. The method of claim 5, wherein the region of interest is defined depending upon a detected acceleration of the object.

10. The method of claim 5, wherein the region of interest is defined depending upon a time since the object was last detected and a motion vector of the object.

11. A method comprising:
acquiring information, for an object moving at or near a display, describing detected locations of the object over time;
processing the information to repeatedly generate a predicted location of the object; and
continuing to perform an image comparison operation that is limited to a region of interest that includes the predicted location even when the object is no longer detected.

12. An apparatus comprising:
a display;
a vision system configured for capturing an image of the display; and
means for controlling a graphical user interface presented at the display and for controlling the vision system to limit capturing of the image to a region of interest within the display, the region of interest including a predicted next location of an object detected at or near the display.

13. The imaging apparatus of claim 12, wherein the means for controlling includes an operating system.

14. The imaging apparatus of claim 12, wherein the means for controlling includes application software.

15. An apparatus comprising:
a storage device upon which is stored a computer-executable program which when executed by a processor enables the processor
to control a graphical user interface presented at a display and to process information pertaining to an object detected at or near the display to determine a predicted location of the object in the future,
to process the information to determine a region of interest within the display that includes the predicted location, and
to generate an output signal that controls an image capture device to image a subportion of the display corresponding to the region of interest.

16. The apparatus of claim 15, wherein the computer-executable program includes an operating system.

17. The apparatus of claim 15, wherein the computer-executable program includes application software.

18. An apparatus comprising:
a display for providing an interactive graphical user interface;
a vision system configured for capturing an image of the display to determine a location of an object facing the display; and
a processing device programmed to control the display and the vision system and to perform an image comparison using an imaged region of interest less than an available area of the display.

19. The apparatus of claim 18, wherein the display is a touch screen.

20. The apparatus of claim 18, wherein the processing device runs an operating system that generates the interactive graphical user interface and communicates the imaged region of interest to the vision system.

21. The apparatus of claim 18, wherein the processing device runs an application program that generates the interactive graphical user interface and communicates the imaged region of interest to the vision system.

22. The apparatus of claim 18, wherein the processing device is programmed to monitor changes in a detected location of the object and to use the changes to define the imaged region of interest.

23. The apparatus of claim 18, wherein the processing device is programmed to use a detected size of the object to define the imaged region of interest.

24. The apparatus of claim 18, wherein the processing device is programmed to modify the imaged region of interest depending upon a predicted location of the object.

25. The apparatus of claim 18, wherein the processing device is programmed to modify the imaged region of interest depending upon an object vector.

26. The apparatus of claim 18, wherein the processing device is programmed to adjust an image capturing frequency depending upon prior detected locations of the object.

27. The apparatus of claim 18, wherein the processing device is programmed to increase a size of the imaged region of interest if a detected location of the object becomes unknown.

28. The apparatus of claim 18, wherein the processing device is programmed to reposition the imaged region of interest depending upon prior detected locations of the object independent of whether a current object location has been detected.
